(19) United States
(12) Patent Application Publication
(10) Pub. No.: US 2008/0153484 A1
(43) Pub. Date: Jun. 26, 2008

(54) QUALITY OF SERVICE IMPROVEMENT IN MOBILE NETWORKS

(75) Inventors: Stephanie Boni, Montreal (CA); Yves Lemieux, Kirkland (CA)

Correspondence Address: ERICSSON CANADA INC.;PATENT DEPARTMENT, 8400 DECARIE BLVD., TOWN MOUNT ROYAL, QC, H4P 2N2, omitted

(73) Assignee: TELEFONAKTIEBOLAGET LM ERICSSON (PUBL), Stockholm (SE)

(21) Appl. No.: 11/614,337

(22) Filed: Dec. 21, 2006

(51) Int. Cl. H04Q 7/20

(52) U.S. Cl. 455/433

(57) ABSTRACT

Device, nodes and methods according to the present invention address this need and others by improving the quality of service of roaming cellular communications, particularly for the area of data transmissions. A service identifier number is transmitted by a mobile device, and received by a telecommunication system. The service identifier number is used to identify a telecommunication node which is assigned to provide the requested data service.

### TECHNICAL FIELD

The present invention relates generally to telecommunications systems, and in particular to methods and systems for improving the Quality of Service (QoS) in roaming applications associated therewith.

### BACKGROUND

At its inception cellular phone technology was designed and used for voice communications only. As the consumer electronics industry continued to mature, and the capabilities of processors increased, more devices became available for public use that allowed the transfer of data between devices and more applications became available that operated based on their transferred data. Of particular note are the Internet and local area networks (LANs). These two innovations allowed multiple users and multiple devices to communicate and exchange data between different devices and device types. With the advent of these devices and capabilities, users (both business and residential) found the need to transmit data, as well as voice, from mobile locations.

In addition to lower costs and more coverage, this has helped drive the next generation of cellular devices to have the ability to transmit and receive data. For example, one of the second generation implementations of cellular phone technology was the Global System for Mobile Communications (GSM). GSM was originally a digital voice technology. An ability to transmit and receive data was grafted on to this system in what could be called generation 2.5 through the use of General Packet Radio Services (GPRS) in combination with the GSM system. GPRS allows mobile phones that use the GSM system to transmit internet protocol (IP) packets. The third generation system that inherits parts of the GSM system is called the Universal Mobile Telecommunications System (UMTS). The UMTS has higher data transmission rates than GSM/GPRS and allows for new and improved options for a mobile user, such as mobile video conferencing.

Among other features, UMTS networks offer improved services to users while they are outside of their normal geographic zones. The ability to access services while one is outside of their home network is typically known as roaming. To access data services while a user is roaming, that user's signaling is first forwarded to a Gateway GPRS Support Node (GGSN) router located in the user's home network so that user can access the particular services to which she or he has subscribed. Then, the user's signaling is forwarded to the desired destination. The GGSN router that manages routing and forwarding for the mobile user is identified by a user's mobile equipment by an Access Point Name (APN).

APNs are a part of the activate Packet Data Protocol (PDP) context request message which is sent by a user's mobile device. This message is sent to a Serving GPRS Support Node (SGSN). An APN contains the name of an access point for GPRS and typically includes an IP network to which a mobile device can be connected. The two principal functions that an APN fulfills are as follows: (1) an APN indicates without ambiguity the Packet Data Network (PDN) which the mobile user wishes to reach; and (2) the APN identifies a service which the mobile user wishes to access. A PDN is a network providing a data service, an example of which is the Internet. Each Public Land Mobile Network (PLMN) can be connected to several PDNs through one or more GGSNs. With the APN, the access point to a PDN in a particular PLMN can be specified by using a name that is compliant to the Domain Name System (DNS) naming system for a given GGSN.

More specifically, an APN consists of up to 100 octets, wherein an octet is the equivalent of an 8-bit byte, and is made up of two parts. The two parts of an APN are the Network Identifier, which is mandatory, and the APN Operator Identifier which is optional. The APN Network Identifier describes the external network to which the GGSN is connected and, optionally, the service that is required by the mobile terminal. The APN Network Identifier has a maximum length of 63 bytes (or 63 ASCII characters). Moreover, in order to guarantee the uniqueness of the network identifiers in a PLMN, all network identifiers consisting of more than one label correspond to an Internet domain name allocated by the PLMN for the purpose of identifying an organization that has reserved this label.

Each operator has a default APN Operator Identifier which is composed of three fields. The first and second fields together uniquely represent a PLMN network. The third field is required to be “gprs”. More specifically, the first field contains three digits and represents the mobile country code (MCC). The second field, which also contains three digits, is called the mobile network code (MNC) and identifies the mobile home PLMN network. Thus, an example of the standard format of an APN Operator Identifier is “mcc.345.mnc012.gprs” for an MCC=345 and an MNC=12. This exemplary APN Operator Identifier is used while roaming inter-PLMN and when the APN translation is made into the Internet Protocol (IP) address of a GGSN from the home PLMN.

Additionally, an APN is usually geographically dependent, such that the APN often refers to a GGSN located in the mobile user's home network and not in the network within which the mobile user is roaming. This geographical anchoring can cause delays due to the travel length. For example, suppose that a mobile user has his or her local service based in the United States and is on a trip to Sweden. The mobile user makes a local phone call, but due to his or her mobile unit being local to the United States, the call is routed to the home base (GGSN) in the United States first before being forwarded to the local number in Sweden. This delay can be increased depending upon, for example, the type/size of the data being transmitted. Additionally problems can be encountered because a user's home address/source address is different from the roaming address, which can cause packets to be dropped due to security functions. As more and more users become members of the mobile network, and some of these users travel farther and farther away from their home address, it is expected that these problems will increasingly (and negatively) affect the user's quality of service (QoS).

Accordingly the present invention addresses the need for improving the QoS in mobile networks.

### SUMMARY

According to an exemplary embodiment, a telecommunication node includes a processor for receiving a message which requests a data service, wherein the message contains a service identification number which is used by the telecommunication node to determine a Gateway GPRS Support Node (GGSN) to support the data service.

According to another exemplary embodiment, a telecommunication method includes a step of receiving a message which requests a data service, wherein the message contains a service identification number which is used by a telecommunication node to determine a Gateway GPRS Support Node (GGSN) to support the data service.

According to a further exemplary embodiment, a mobile device includes a transceiver for transmitting a message which requests a data service, and wherein the message contains a service identification number which is usable to determine a Gateway GPRS Support Node (GGSN) to support the data service.

According to still another exemplary embodiment, a telecommunication method includes a step of transmitting a message which requests a data service, and wherein the message contains a service identification number which is usable to determine a Gateway GPRS Support Node (GGSN) to support the data service.

In yet another exemplary embodiment, a telecommunications node includes a processor for receiving router advertisement (RA) messages and for updating a Gateway GPRS Support Node (GGSN) list which is used to assign a GGSN to locally support a request for data service, wherein the processor invokes a home GGSN IP address discovery mechanism when the request is unable to be locally supported.

According to another exemplary embodiment, a telecommunications method includes the steps of receiving router advertisement (RA) messages, updating a Gateway GPRS Support Node (GGSN) list using the RA messages, assigning a GGSN to locally support a request for data service, and invoking, if the request cannot be supported locally, a home GGSN IP address discovery mechanism.

### BRIEF DESCRIPTION OF THE DRAWINGS

The accompanying drawings illustrate exemplary embodiments of the present invention, wherein:

FIG. 1(a) depicts an exemplary Universal Mobile Telecommunications System (UMTS) including two PLMNs;

FIG. 1(b) shows a portion of the system of FIG. 1(a) in more detail;

FIG. 1(c) depicts an exemplary user equipment (e.g., mobile device) operable within the system of FIG. 1(a);

FIG. 1(d) shows an exemplary telecommunications node (e.g., a GGSN/SGSN) operable within the system of FIG. 1(a);

FIG. 2 illustrates a first scenario involving roaming mobile communications according to exemplary embodiments;

FIG. 3 is a flowchart illustrating a method for constructing a GGSN list according to an exemplary embodiment;

FIG. 4 is a flowchart illustrating a GGSN selection mechanism according to an exemplary embodiment;

FIG. 5 illustrates a second scenario involving roaming mobile communications according to exemplary embodiments;

FIG. 6 illustrates a third scenario involving roaming mobile communications according to exemplary embodiments; and

FIG. 7 is a flowchart showing a method for determining whether to create a PDP context request message or to reject an activate PDP context request message according to an exemplary embodiment.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

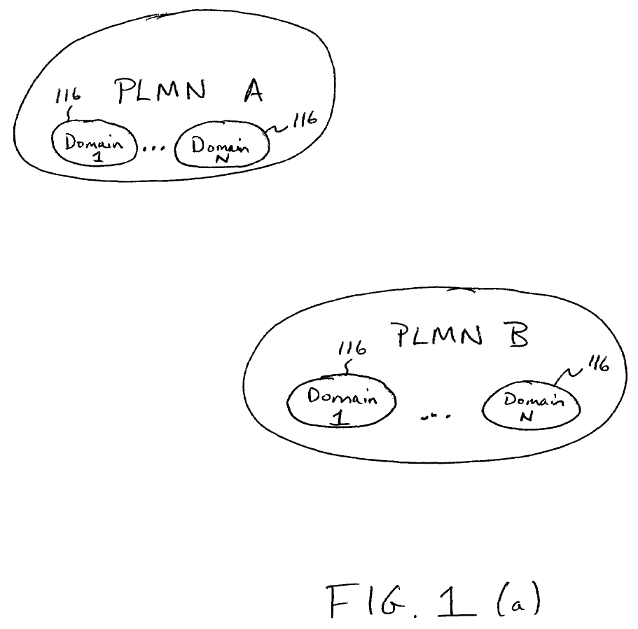

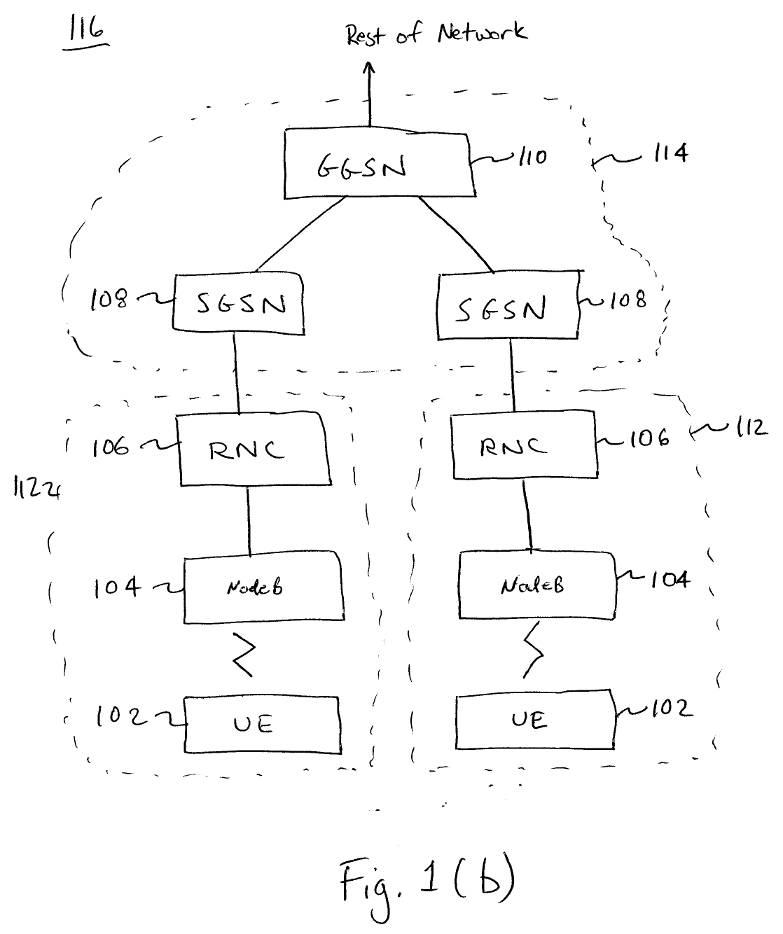

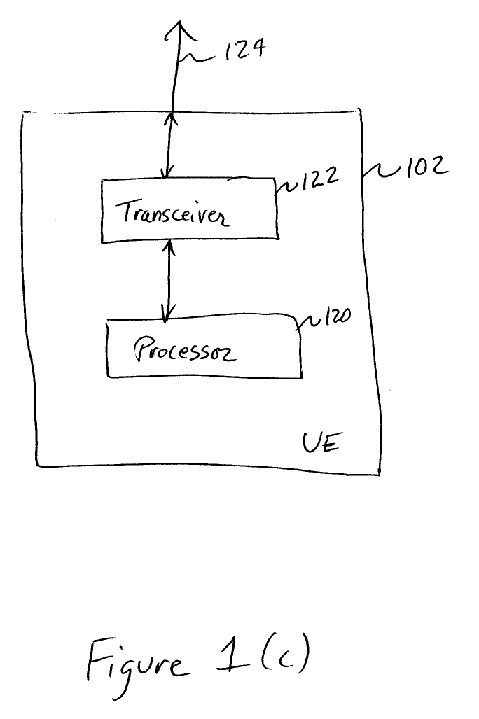

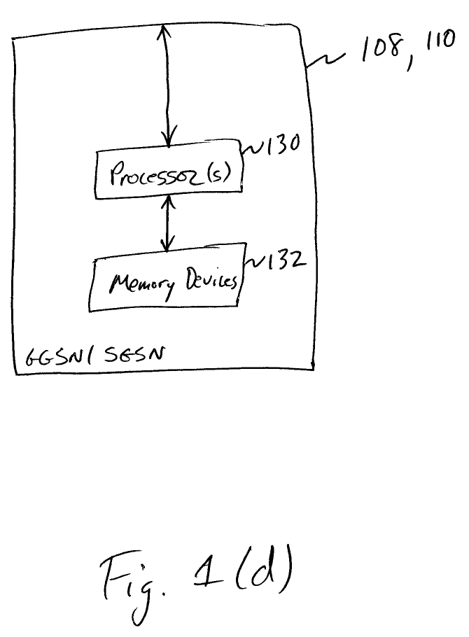

In order to provide some context for this discussion, an exemplary aggregated mobile system in which the present invention can be implemented will first be described with respect to FIGS. 1(a)-1(d). Those skilled in the art will appreciate, however, that the present invention is not restricted to implementation in this type of mobile system and that more or fewer components can be included therein.

In this exemplary embodiment, the Universal Mobile Telecommunications System (UMTS) network depicted in FIG. 1(a) includes two public land mobile networks (PLMNs) A and B each of which include a number of different UMTS administrative domains 116. The administrative domain 116 can be further broken down into two segments, the UMTS radio access network (UTRAN) 112s and the core network (CN) 114 as seen in FIG. 1(b). The UTRANs 112s include user equipment (UE) 102 in communication with NodeB 104, e.g., via an air interface as specified in the UMTS standards, in communication with a radio network controller (RNC) 106. The CN 114 consists of SGSNs 108s in communication with both a Gateway GPRS Support Node (GGSN) 110 (which is in the CN) and the RNCs 106s from the UTRAN. Additionally, while not specifically shown, the links shown in FIG. 1(b) depict both one-way and two-way communications.

FIG. 1(c) illustrates an exemplary UE in which exemplary embodiments can be implemented. Therein, the UE 102 includes a processor 120 connected to a transceiver 122. The transceiver 122 is, in turn, connected to an air interface via an antenna 124. It will be appreciated that UEs 102 will typically also include other elements, e.g., a display and memory devices. Similarly, telecommunication nodes, such as the GGSNs and SGSNs, can include processor(s) 130 and memory devices 132 as shown in FIG. 1(d), for performing various functions to be described below.

According to an exemplary embodiment of the present invention, in order to improve QoS in a UMTS system the Access Point Name (APN) described in the background is replaced by a service identification number (ServiceID). This Service ID, in conjunction with other features described below, fulfills the functions of an APN. More specifically, the ServiceID is a mechanism for indicating the Packet Data Network (PDN) which a mobile user wishes to reach and can, alternatively, identify a class of service which the user desires to use.

According to this exemplary embodiment, the ServiceID is a number, and has a format using five bytes as shown in Table 1.

TABLE 1
Exemplary ServiceID Format

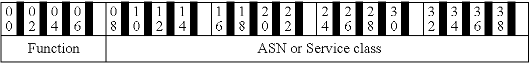

The exemplary Service ID number of Table 1 can be described in two parts or fields. The first part is the function field and the second part is the Autonomous System Number (ASN) or service class field. In this example, the first byte constitutes the function field which is used to discriminate the function filled by the ServiceID in a particular instance, e.g., such as identification of a desired PDN or identification of a desired service. For example, the function field can take one of the following values according to this exemplary embodiment:

0 (Ob00000000): this value corresponds to a ServiceID wild card;

1 (Ob000000001): this value shows that this ServiceID indicates a PDN; and

3 (Ob000000011): this value shows that this ServiceID indicates a service.

For this exemplary embodiment, these are the only values that the function field can take. Thus, for this embodiment, if the function field contains values other than those defined, the ServiceID will be regarded as invalid or erroneous. However, it is to be understood that, as other options become available in the future, these field values could be modified as desired. The function field may have more, fewer or different values according to other exemplary embodiments.

Turning now to the second field in the ServiceID (ASN or service class), when the function field has the value 0, the number represented by the last four bytes will be 0. A function field containing the value 1 indicates a desired PDN, which is a network providing a data service. Thus, a ServiceID with a function field value of 1 describes the access point to a PDN independently of the PLMN. More specifically, when the function field has the value 1, the last four bytes of the ServiceID represent an ASN of 32 bits indicating a given PDN. The ASN is a number that makes it possible to uniquely identify each Autonomous System (AS). An AS is a group of Internet Protocol (IP) networks managed by one or more operators sharing only one routing policy. The ASNs are assigned by the Internet Assigned Number Authority (IANA).

When the Function field of a ServiceID has a value of 3, then the second field of the ServiceID is used to describe one of a number of different service classes. These service classes can be broken down into, for example, four QoS classes based upon the degree of sensitivity to potential traffic delay. When the ServiceID indicates a service, the last four bytes of the ServiceID will be able to take four values exactly corresponding to the following four UMTS service classes, according to this exemplary embodiment:

1.0.0.0 (0b00000001.00000000.00000000.00000000): this value corresponds to the class “conversational”;

3.0.0.0 (0b00000011.00000000.00000000.00000000): this value corresponds to the class “streaming”;

7.0.0.0 (0b00000111.00000000.00000000.00000000): this value corresponds to the class “interactive”; and

15.0.0.0 (0b00001111.00000000.00000000.00000000): this value corresponds to the class “background”.

To better understand how the ServiceIDs described above are used by exemplary embodiments of the present invention, e.g., both in the network and in the user equipment, the following detailed examples illustrate some usage cases wherein a roaming user accesses the network using the ServiceID. More specifically, three exemplary scenarios according to the present invention are described below for accessing a mobile network using a ServiceID according to these exemplary embodiments. These three scenarios can generally be described as follows: (1) the case wherein a roaming user's communications are managed by a visited GGSN; (2) the case wherein a roaming user's communications are managed by a home GGSN, e.g., due to refused permission from the visited GGSN; and (3) the case where a roaming user's communications are managed by a home GGSN due to the visiting networks inability to handle the request.

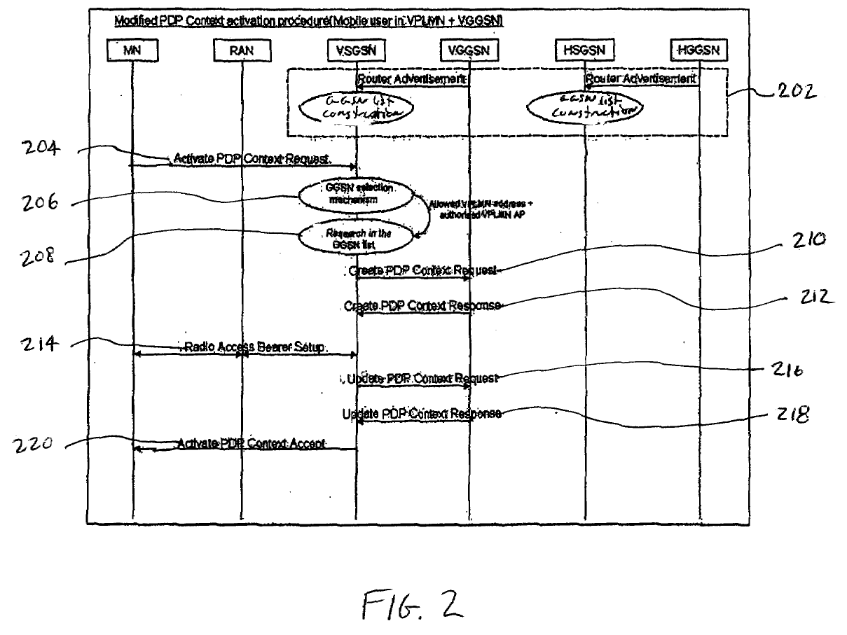

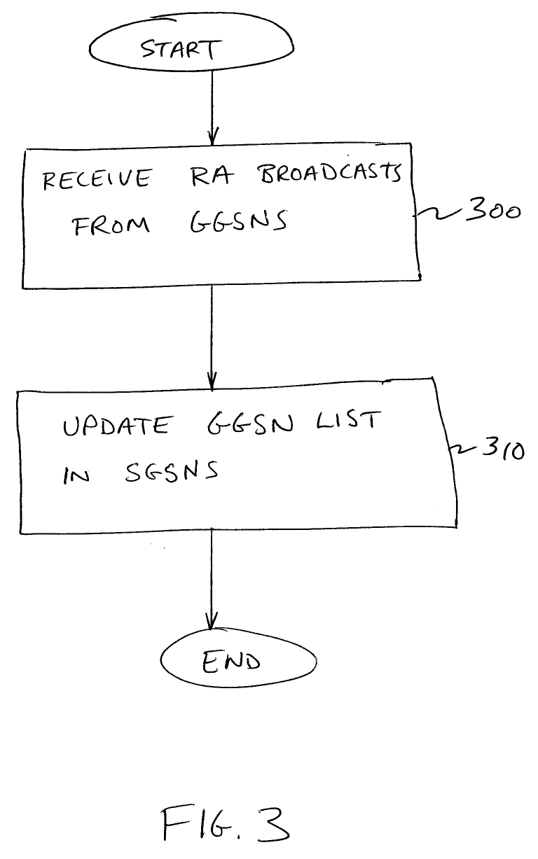

In the first scenario, a roaming user's communications are managed by a visited GGSN (VGGSN) when a user is in a visited PLMN (VPLMN) as shown in FIG. 2. In this scenario, the mobile user has the authorization both to use the visited PLMN's services (i.e., it has an allowed VPLMN address) and access to the VPLMN access point. A preliminary step 202 involves constructing a GGSN list (indexed by ServiceID) within each SGSN 108. This construction step 202 can be performed periodically and is independent of the PDP context activation procedure described in the rest of FIG. 2. More specifically, the GGSN list construction step 202 provides a data structure within each SGSN 108 which the SGSN can use to determine which GGSN to assign to provide the requested service. An exemplary GGSN list construction method according to an exemplary embodiment of the present invention is illustrated in the flowchart of FIG. 3.

Therein, at step 300, each GGSN 110 within a particular PLMN periodically broadcasts a message to the various SGSNs 108, referred to herein as a router advertisement (RA) message, within the same PLMN. This router advertisement message informs the SGSNs 108 of the identities of the available GGSNs 110, as well as the services which each GGSN 110 is able to provide to users. According to one exemplary embodiment, the router advertisement message can be implemented in a manner similar to the neighbor discovery procedure described in Mobile IP version 6 (MIPv6) protocol as described, for example, in the standards document RFC 2461 “Neighbor Discovery for IPv6”, 1998, the disclosure of which is incorporated here by reference. As the SGSNs 108 receive the router advertisement messages, they will use them to update their locally stored GGSN lists to include, among other things, each GGSN's IP address and the services that it supports at step 310.

In order to support the functionality associated with the GGSN list construction mechanism illustrated in FIG. 3, some modifications can be made to the router advertisement procedures which are described in the above-incorporated by reference standards document. For example, the format of the MIPv6 RA message can be modified to add two new flags, e.g., a “G” and an “H” flag, thereto. The flag G indicates that the transmitting entity associated with a particular router advertisement message can act as GGSN, while the flag H indicates that the message transmitting router is used as a Home Agent on the given link. The format of the modified RA message according to this exemplary embodiment is presented in Table 2.

TABLE 2
Modified MIPv6 Router Advertisement message format

| Type | Code | | | | Checksum |
|---|---|---|---|---|---|
| Cur Hop Limit | M | O | H | Reserved | Router Lifetime |

Reachable time
Retrans timer
Options

Additionally, the option field illustrated above in the RA message of Table 2 can be defined in a manner so as to convey relevant information about the GGSN which is broadcasting the messages for purposes of building the GGSN list, e.g., including specific information on specific router functionality. The format of this option is presented in Table 3.

TABLE 3
GGSN Information option format

| | | |
|---|---|---|
| Type | Length | Reserved |

| | |
|---|---|
| GGSN Preference | GGSN Lifetime |

ServiceIDs

The specific fields used in the GGSN Information option format according to this exemplary embodiment and as shown in Table 3 will now be described. Therein, the Type field is Neighbor Discovery option described in the above-incorporated by reference document. The Length field contains, e.g., an unsigned 8-bit integer indicating the length of the option. The GGSN Preference field contains, e.g., an unsigned 16-bit integer indicating the preferences of the GGSN. For this latter field, a high value indicates a high availability and can be used by the receiving SGSNs to order the GGSN list created in FIG. 3, e.g., an SGSN might rank GGSNs which can provide a particular service class or ASN in order from high to low availability. If this option is not included in an RA which has the flag G, the value of the GGSN Preference field is set to zero. The GGSN that sent the RA can dynamically determine the value of the GGSN Preference field, according to, for example, the number of mobile users which it currently serves or the amount of resources still available to serve other mobile users.

The GGSN Lifetime field contains, e.g., an unsigned 16-bit integer indicating the lifetime of the GGSN in seconds. By default, this field takes the value of the lifetime of the router as specified in the principal body of a RA message. A value of zero is not preferred. The GGSN Lifetime field applies, according to this exemplary embodiment, only to the functionality of the router as a GGSN and not to the information in the other fields or options of the RA message. The ServiceIDs field is a list of ServiceIDs relating to the service classes or ASNs which the GGSN transmitting this RA message is able to provide. ServiceIDs can be placed contiguously within the ServiceID field of the options portion of an RA and parsed by the receiving SGSNs based upon a known length of, e.g., 5 bytes each.

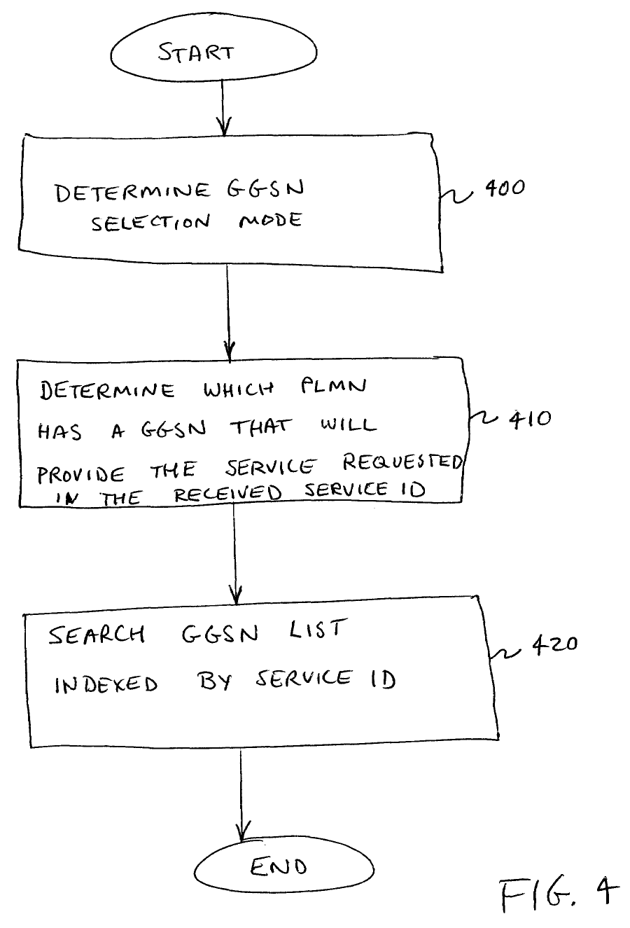

Having described an exemplary GGSN list construction method which can be performed as step 202, and returning to the scenario of FIG. 2, at step 204, the mobile user sends an Activate PDP context request message (including a ServiceID as described above) to the SGSN 108 of the PLMN in which the mobile unit currently is located. Since the mobile user is roaming, it is an SGSN of the visited network (VSGSN) which deals with the Activate PDP context request message at step 204. After receiving the Activate PDP context request message, the VSGSN checks the user's subscription records to establish the validity of the request. Once the validity of the mobile user's request is established, the VSGSN applies a GGSN selection mechanism and search of the GGSN list in steps 206 and 208, respectively, to determine which GGSN should be assigned to service this particular request for data services. An exemplary GGSN selection mechanism is illustrated in the flowchart of FIG. 4.

Therein, at step 400, a GGSN selection mode which is operative to process this particular GGSN selection is determined. Various GGSN selection modes may be provided for depending upon the particular implementation of these exemplary embodiments. According to one exemplary embodiment, there are three GGSN selection modes from which a selection can be made at step 400: (1) ChosenByMN (chosen by the mobile network or user equipment) whereby the ServiceID is the ServiceID in the Activate PDP Context Request message; (2) ChosenBySGSN whereby the ServiceID is the default ServiceID associated with the known PDP type; and (3) Subscribed whereby ServiceID is extracted from the PDP context. The selection of a particular mode can be made by the network based upon parameters in the Activate PDP context request message and/or records in the Home Location Register (HLR) associated with the mobile user that transmitted the request message. Regardless, it will be appreciated that the GGSN selection mechanism of step 400 is a manner of selecting the ServiceID (i.e., either that transmitted by the mobile user or another) which will, in turn, be used to select a particular GGSN to provide the requested service.

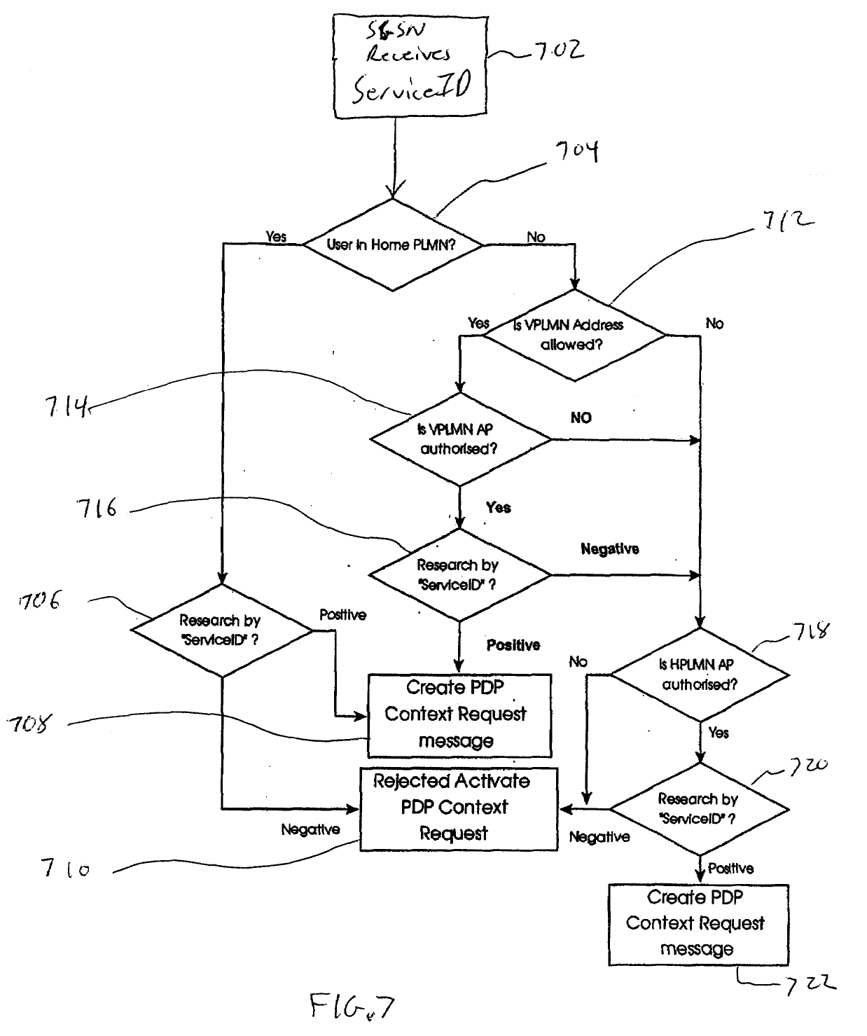

Next, at step 410, it is determined which PLMN, i.e., the visited PLMN or home PLMN, will provide the data service identified by the ServiceID. In the exemplary scenario of FIG. 2, this will be the visited PLMN since the mobile user has the authorization to use the visited PLMN's services (i.e., it has an allowed VPLMN address). A more detailed, exemplary method for implementing step 410 is described below with respect to FIG. 7. Then, at step 420, a search is performed in the GGSN list indexed by ServiceID to select a particular GGSN (VGGSN in the example of FIG. 2) for providing service. If a suitable GGSN cannot be identified as a result of the search, then the PDP context activation request is then rejected.

Returning to FIG. 2, once a VGGSN is selected, at step 210 the VSGSN sends a create PDP context request message to the VGGSN whose IP address was obtained in step 208. The VGGSN creates a new entry in its table of PDP contexts which will allow it to route the user's packets between the HSGSN and the network PDN. In step 212, the VGGSN sends back a create PDP context response message to the VSGSN. If the VGGSN is responsible for the allowance of the PDP address, this address is included in the PDP context response message. Otherwise, the corresponding field is set to 0.0.0.0, indicating that the mobile user needs to negotiate a PDP address with an external PDN after the completion of this procedure.

Next, a Radio Access Bearer Setup procedure is undertaken in step 214. Step 214 can involve a QoS modification. If the QoS parameters were modified in step 214, the VSGSN and the VGGSN exchange update PDP context request and update PDP context response messages in order to modify these QoS parameters in the PDP context in steps 216 and 218, respectively. The VSGSN then sends an activate PDP context accept message to the MN (or user equipment) to conclude the procedure in step 220.

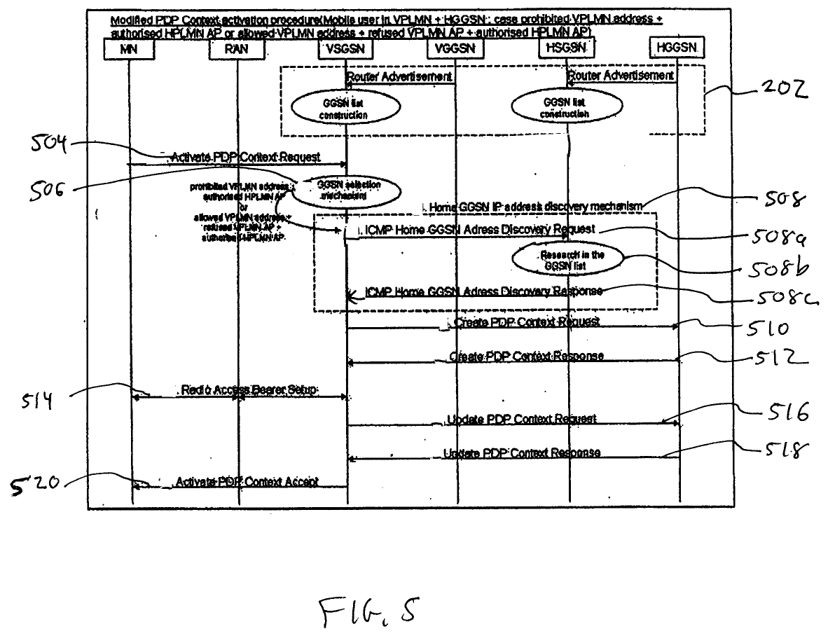

FIG. 5 illustrates a second scenario in which a roaming user's communications are managed by a home GGSN when a user is in a visited PLMN according to another exemplary embodiment. In this scenario, the mobile user's communications are managed by an HGGSN because of, e.g., a refused permission to use the visited network's services. As with the previously described exemplary embodiment, a GGSN list construction step 202 will be performed periodically by the SGSNs, e.g., in the manner described above. Then, in step 504, the mobile user sends an activate PDP context request message to the SGSN of the PLMN in which the mobile unit currently is located. Since the mobile user is roaming, it is an SGSN of the visited network (VSGSN) which deals with the Activate PDP context request message.

Thereafter, the VSGSN checks the user's subscription records to establish the validity of the request. Once the validity of the mobile user's request is established, the VSGSN applies the GGSN selection mechanism (illustrated in FIG. 4) in step 506. Unlike the previous exemplary embodiment, when the process reaches step 410 in the GGSN selection mechanism of FIG. 4, it will be determined that the relevant PLMN is the home PLMN rather than the visited PLMN since the mobile user in this case either does not have authorization both to use the visited PLMN's services (i.e., it has does not have an allowed VPLMN address) and/or does not have access to the VPLMN access point.

In this scenario, since permission is refused by the system to use a local GGSN to provide service, the VSGSN needs to obtain a home GGSN's IP address associated with this mobile user. The GGSN list constructed at step 202 provides a list of local GGSNs and their attributes. However, the list of GGSNs in operation in another PLMN is inaccessible to SGSNs. Additionally, since the ServiceID provided by the mobile user in the Activate PDP Context Request is a number rather than a DNS address, the ServiceID does not provide a direct mechanism for accessing an HSGSN. Accordingly, these exemplary embodiments also provide a home GGSN IP addresses discovery mechanism to deal with those situations, such as that illustrated in FIG. 5, where signaling back to the home system becomes necessary. As compared with the GGSN list construction procedure described above which is performed periodically and not upon request, this Home GGSN IP address discovery mechanism intervenes only when an access by the Home PLMN is selected as part of the GGSN selection mechanism of FIG. 4 according to these exemplary embodiments.

According to an exemplary embodiment, a home GGSN IP address discovery procedure 508 is carried out in the form of an exchange of messages between the SGSN of the visited PLMN (VSGSN) and an SGSN of the home PLMN (HSGSN) of the mobile user. The message 508a sent by the VSGSN for the purposes of this address discovery contains the ServiceID of the service which the GGSN must provide and is addressed to an address that makes it possible to join all the SGSNs of the Home PLMN. According to an exemplary embodiment, the message form can be similar to the Router Solicitation message used in above-incorporated by reference Neighbor Discovery protocol but modified for use with the ServiceID. This message 508a is referred to herein as the Internet Control Message Protocol (ICMP) Home GGSN Address Discovery Request. The ICMP Home GGSN Address Discovery Request format is presented in Table 4.

TABLE 4
ICMP Home GGSN Address Discovery Request message format

| | | |
|---|---|---|
| Type | Code | Checksum |

| | |
|---|---|
| Identifier | Reserved |

Service ID

In Table 4, according to this exemplary embodiment, the Type field value is set to 154 in order to differentiate this ICMP message from other ICMP messages. The Code field is set to 0. The Checksum field is set to ICMP checksum. The Identifier field uses an identifier which allows the system to pair an ICMP Home GGSN Address Discovery Request message with the corresponding ICMP Home GGSN Address Discovery Response message. The Reserved field is reserved for future use, but initially set to 0. The ServiceID field displays the ServiceID of the service which is to be provided by the GGSN which is being identified within the home PLMN by this discovery mechanism.

The ICMP Home GGSN Address Discovery Request Message is sent to the roaming user's home SGSN unicast address by the SGSN of the visited network. The SGSN which receives this ICMP Home GGSN Address Discovery Request message carries out a search in its own GGSN list using the ServiceID contained in the message at step 508b. The SGSN then responds with an ICMP Home GGSN Address Discovery Response message 508c. Assuming a successful search, the ICMP Home GGSN Address Discovery Response message 508c contains a code indicating success as well as the GGSN IP address found. Otherwise, the message 508c contains a code indicating failure and the cause of failure. The ICMP Home GGSN Address Discovery Response message 508c is used by the SGSN of the roaming user's home network to answer the SGSN of the visited network which initiated the Home GGSN IP address discovery mechanism. An exemplary format for message 508c is presented in Table 5.

TABLE 5
ICMP Home GGSN Address Discovery Response Message Format

| | | |
|---|---|---|
| Type | Code | Checksum |

| | |
|---|---|
| Identifier | Reserved |

Home GGSN Address

In Table 5, the Type field is set to 155 in order to differentiate this ICMP message from other ICMP messages. The Code field indicates whether the search in the GGSN list was successful or not. According to this exemplary embodiment, a value between 0 and 127 indicates a success, e.g., when the Home GGSN Address field contains the desired GGSN's IP address. If a failure in the search occurs, the value of the code lies between 128 and 255, which indicates that there was an error in the Home GGSN Address field. The Checksum field indicates an ICMP checksum. The Identifier field contains an identifier coming from ICMP Home GGSN Address Discovery Request message that allows the recipient to correlate the response with the earlier request in message 508a. The Reserved field is reserved for future use and is initially set to 0. The Home GGSN Address field contains the GGSN's IP address which was located by the GGSN list search or the cause of the error which resulted in a search failure.

If the ICMP Home GGSN address discovery response message 508c contains the HGGSN's IP address the process continues, otherwise the PDP context activation procedure is terminated. In step 510, the VSGSN sends a create PDP context request message to the HGGSN whose IP address was obtained in step 508. The HGGSN creates a new entry in its table of PDP contexts which will allow it to route the user's packets between the VSGSN and the network PDN. In step 512, the GGSN sends back a create PDP context response message to the VSGSN. If the HGGSN is responsible for the allowance of the PDP address, this is included in the create PDP context response message. Otherwise, the corresponding field is set to 0.0.0.0 indicating that the mobile user needs to negotiate a PDP address with an external PDN after the completion of this procedure. Next, a Radio Access Bearer Setup procedure is undertaken in step 514. Step 514 can involve a QoS modification. If the QoS parameters were modified in step 514, the VSGSN and the HGGSN exchange update PDP context request and update PDP context response messages in order to modify these QoS parameters in the PDP context in steps 516 and 518, respectively. The VSGSN then sends an activate PDP context accept message to MN (or user equipment) to conclude the procedure in step 520.

It will be appreciated by those skilled in the art that this second described scenario can be caused by at least one of two situations. More specifically, the exchange of messages described in this second scenario occurs if either the user does not have the right to use the visited network's service (due to a prohibited VPLMN address for example) or if the mobile user has the right to use the services, but access to the VPLMN's access point is refused to the mobile user.

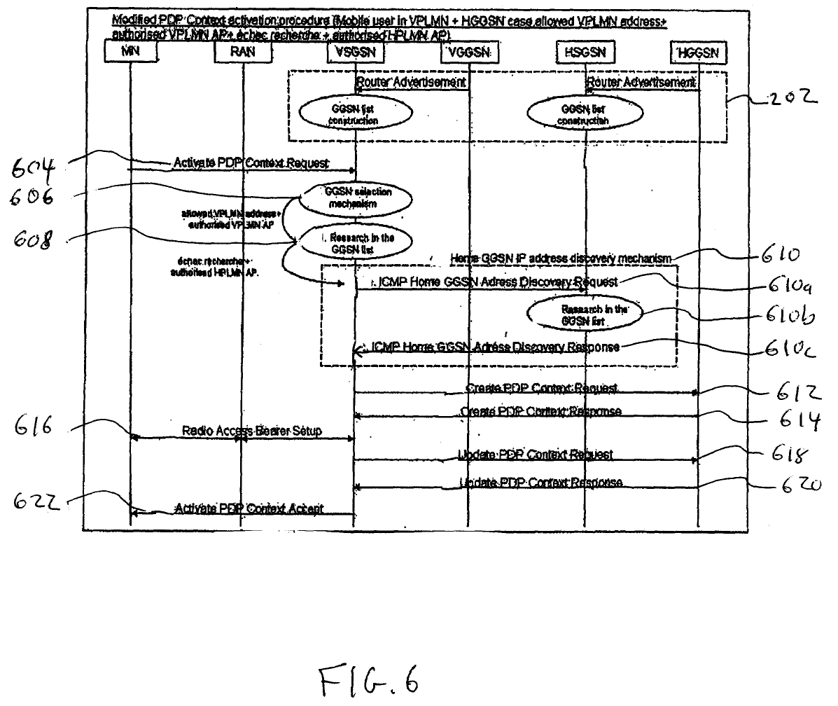

In the third scenario, a roaming user's communications are managed by a home GGSN when a user is in a visited PLMN as shown in FIG. 6. In this scenario, the MN has the right to use the visited PLMN's services as well as the authorization to reach the VPLMN's access point, unlike the scenario described above with respect to FIG. 5, but the search of the VSGSN's GGSN list resulted in a failure. As with the previously described exemplary embodiment, a GGSN list construction step 202 will be performed periodically by the SGSNs, e.g., in the manner described above.

Then, in step 604, the mobile user sends an activate PDP context request message to the SGSN of the PLMN in which the mobile unit currently is located. Since the mobile user is roaming, it is an SGSN of the visited network (VSGSN) which deals with the Activate PDP context request message. Thereafter, the VSGSN checks the user's subscription records to establish the validity of the request. Once the validity of the mobile user's request is established, the VSGSN applies the GGSN selection mechanism, described above, in step 606. In step 608, the IP address of a VGGSN intended to provide the service whose ServiceID was selected (at step 400 of FIG. 4) is searched for within the previously constructed GGSN list. However, in step 608 the search of the VSGSN's GGSN list results in a failure. The result of this search failure is that the VSGSN needs to interact with the HSGSN in a similar manner to that described above with respect to the second scenario.

Thus, the three step Home GGSN IP address discovery mechanism is launched in step 610. In the first part, step 610a, the VSGSN sends an ICMP Home GGSN address discovery request message containing the selected ServiceID to the SGSN unicast address of the mobile user's home PLMN. The home PLMN's SGSN receives the ICMP Home GGSN address discovery request message, in step 610b, and performs a search in its GGSN list using the received ServiceID. An ICMP Home GGSN address discovery response message is transmitted back to the originating VSGSN containing either the HGGSN's IP address or an error message in step 610c. If the ICMP Home GGSN address discovery response message contains the HGGSN's IP address, the process continues, otherwise the PDP context activation procedure is terminated.

In step 612, the VSGSN sends a create PDP context request message to the HGGSN whose IP address was obtained in step 610. The HGGSN creates a new entry in its table of PDP contexts which will allow it to route the user's packets between the VSGSN and the network PDN. In step 614, the GGSN sends back a create PDP context response message to the VSGSN. If the HGGSN is responsible for the allowance of the PDP address, this is included in the create PDP context response message. Otherwise, the corresponding field is set to 0.0.0.0 indicating that the mobile user needs to negotiate a PDP address with an external PDN after the completion of this procedure. Next, a Radio Access Bearer Setup procedure is undertaken in step 616. Step 616 can involve a QoS modification. If the QoS parameters were modified in step 616, the VSGSN and the HGGSN exchange update PDP context request and update PDP context response messages in order to modify these QoS parameters in the PDP context in steps 618 and 620 respectively. The VSGSN then sends an activate PDP context accept message to mobile MN (or user equipment) to conclude the procedure in step 622.

According to the exemplary embodiments described above, three scenarios have been described for accessing a network from a piece of user equipment using a Serviceld, instead of an APN, to select a GGSN (either in the visited network or in the home network) to support services. According to these exemplary embodiments, the system uses a GGSN selection mechanism, generally depicted in FIG. 4, to identify a particular GGSN based upon a received Service ID. Some exemplary logic for determining whether to create a PDP Context Request message or to reject the Activate PDP Context Request message based upon the authorizations granted to a particular mobile user and the results of search the GGSN list in the receiving SGSN is illustrated in FIG. 7.

Initially, in step 702, an SGSN 108 receives a ServiceID from a piece of user equipment. The SGSN 108 then checks to determine if the mobile user is in its Home PLMN in step 704. If the result from step 704 is yes (i.e., the mobile user is in its Home PLMN) then in step 706 the SGSN 108 carries out a search in its GGSN list based upon the received ServiceID. If the result from the search in step 706 is positive, then the PDP context request message is created in step 708. If the result from the search in step 706 is negative, the PDP context activation request is rejected in step 710.

Returning now to step 704, if the result is no, then the user is in a VPLMN. In step 712, the SGSN determines whether or not the user can use the services provided by the VPLMN. If the result from step 712 is a yes, then the SGSN determines if access to the VPLMN's access point is authorized in step 714. If the result from step 714 is yes, then the SGSN searches in its GGSN list based upon the received ServiceID in step 716. A positive search result from step 716 results in a PDP context request message being created, as shown in step 708.

If any of steps 712, 714 or 716 result in a no or a negative decision, then in step 718 the SGSN checks to see if the access to the Home PLMN access point is authorized for the mobile user. If the result in step 718 is a yes, then the SGSN launches the Home GGSN IP address discovery mechanism in step 720 using the previously received ServiceID. Upon a successful receipt of the HGGSN IP address, the PDP context activation request message is created in step 722. If a no or negative result is obtained during either of steps 718 or 720, the PDP context activation request is rejected in step 710.

The foregoing exemplary embodiments provide various benefits associated with the use of a ServiceID, instead of an APN, to support roaming in, for example, UMTS systems. For example, as stated above, the ServiceID uses a number instead of the DNS address contained in the APN, which is geographically anchored. This difference typically provides for an efficiency improvement in the use of roaming services because at least one transmission step is taken out of the data path under those circumstances where it is no longer a requirement for data to be routed through the home GGSN.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A telecommunication node comprising:
a processor for receiving a message which requests a data service, wherein said message contains a service identification number which is used by said telecommunication node to determine a Gateway GPRS Support Node (GGSN) to support said data service.

2. The telecommunication node of claim 1, wherein said message is an activate packet data protocol context request message.

3. The telecommunication node of claim 1, wherein said telecommunication node is a Serving GPRS Support Node (SGSN).

4. The telecommunication node of claim 1, wherein said processor also periodically receives messages from GGSNs which indicate services provided by said GGSNs and IP addresses associated with said GGSNs, and further wherein said telecommunications node includes:
a memory device for storing a GGSN list indexed by service based upon said messages from said GGSNs.

5. The telecommunication node of claim 4, wherein said processor determines whether said data service is authorized to be provided by a GGSN within said telecommunication node's public land mobile network (PLMN) or whether said data service should be provided by a home PLMN.

6. The telecommunication node of claim 5, wherein if said processor determines that said data service is authorized to be provided by a GGSN within said telecommunication node's PLMN, then said telecommunication node searches said GGSN list using said service identification number to identify a GGSN within said telecommunication node's PLMN to provide said data service.

7. The telecommunication node of claim 5, wherein if said processor determines that said data service is not authorized to be provided by a GGSN within said telecommunication node's PLMN, then said telecommunication node initiates a home GGSN IP address discovery mechanism to provide said data service from a GGSN in said home PLMN.

8. The telecommunication node of claim 5, wherein if said processor determines that said data service is authorized to be provided by a GGSN within said telecommunication node's PLMN, and if a search of said GGSN list for a local GGSN to provide said data service fails, then said telecommunication node initiates a home GGSN IP address discovery mechanism to provide said data service from a GGSN in said home PLMN.

9. The telecommunication node of claim 2, wherein said activate packet data protocol context request does not contain an access point name (APN) having a domain name.

10. The telecommunication node of claim 1, wherein said service identification number includes a first field and a second field.

11. The telecommunication node of claim 10, wherein a first field is a function field that contains a first number corresponding to one of: a wildcard, a packet data network and a service.

12. The telecommunication node of claim 11, wherein if said first number corresponds to said packet data network, then said second field contains an autonomous system number.

13. The telecommunication node of claim 11, wherein if said first number corresponds to said service, then said second field contains a service classification number.

14. The telecommunication node of claim 13, wherein said service classification number corresponds to at least one of: a conversational service, a streaming service, an interactive service and a background service.

15. A telecommunication method comprising the step of:
receiving a message which requests a data service, wherein said message contains a service identification number which is used by a telecommunication node to determine a Gateway GPRS Support Node (GGSN) to support said data service.

16. The telecommunication method of claim 15, wherein said message is an activate packet data protocol context request message.

17. The telecommunication method of claim 15, wherein said telecommunication node is a Serving GPRS Support Node (SGSN).

18. The telecommunication method of claim 15, further comprising the steps of:
periodically receiving messages from GGSNs which indicate services provided by said GGSNs and IP addresses associated with said GGSNs, and
constructing a GGSN list indexed by service based upon said messages from said GGSNs.

19. The telecommunication method of claim 18, further comprising the step of:
determining whether said data service is authorized to be provided by a GGSN within said telecommunication node's public land mobile network (PLMN) or whether said data service should be provided by a home PLMN.

20. The telecommunication method of claim 19, further comprising the step of:
searching, if it is determined that said data service is authorized to be provided by a GGSN within said telecommunication node's PLMN, said GGSN list using said service identification number to identify a GGSN within said telecommunication node's PLMN to provide said data service.

21. The telecommunication method of claim 19, further comprising the step of:
initiating, if it is determined that said data service is not authorized to be provided by a GGSN within said telecommunication node's PLMN, a home GGSN IP address discovery mechanism to provide said data service from a GGSN in said home PLMN.

22. The telecommunication method of claim 19, further comprising the step of:
initiating, if it is determined that said data service is authorized to be provided by a GGSN within said telecommunication node's PLMN, and if a search of said GGSN list for a local GGSN to provide said data service fails, a home GGSN IP address discovery mechanism to provide said data service from a GGSN in said home PLMN.

23. The telecommunication method of claim 16, wherein said activate packet data protocol context request does not contain an access point name (APN) having a domain name.

24. The telecommunication method of claim 15, wherein said service identification number includes a first field and a second field.

25. The telecommunication method of claim 24, wherein said first field is a function field that contains a first number corresponding to one of: a wildcard, a packet data network and a service.

26. The telecommunication method of claim 25, wherein if said first number corresponds to said packet data network, then said second field contains an autonomous system number.

27. The telecommunication method of claim 25, wherein if said first number corresponds to said service, then said second field contains a service classification number.

28. The telecommunication method of claim 27, wherein said service classification number corresponds to at least one of: a conversational service, a streaming service, an interactive service and a background service.

29. A mobile device comprising:
a transceiver for transmitting a message which requests a data service, and wherein said message contains a service identification number which is usable to determine a Gateway GPRS Support Node (GGSN) to support said data service.

30. The mobile device of claim 29, wherein said message is an activate packet data protocol context request message.

31. The mobile device of claim 29, wherein said activate packet data protocol context request does not contain an access point name (APN) having a domain name.

32. The mobile device of claim 29, wherein said service identification number includes a first field and a second field.

33. The mobile device of claim 32, wherein a first field is a function field that contains a first number corresponding to one of: a wildcard, a packet data network and a service.

34. The mobile device of claim 33, wherein if said first number corresponds to said packet data network, then said second field contains an autonomous system number.

35. The mobile device of claim 33, wherein if said first number corresponds to said service, then said second field contains a service classification number.

36. The mobile device of claim 35, wherein said service classification number corresponds to at least one of: a conversational service, a streaming service, an interactive service and a background service.

37. A telecommunication method comprising the step of:
transmitting a message which requests a data service, and wherein said message contains a service identification number which is usable to determine a Gateway GPRS Support Node (GGSN) to support said data service.

38. The method of claim 37, wherein said message is an activate packet data protocol context request message.

39. The method of claim 37, wherein said activate packet data protocol context request does not contain an access point name (APN) having a domain name.

40. The method of claim 37, wherein said service identification number includes a first field and a second field.

41. The method of claim 40, wherein said first field is a function field that contains a first number corresponding to one of: a wildcard, a packet data network and a service.

42. The method of claim 41, wherein if said first number corresponds to said packet data network, then said second field contains an autonomous system number.

43. The method of claim 41, wherein if said first number corresponds to said service, then said second field contains a service classification number.

44. The method of claim 43, wherein said service classification number corresponds to at least one of: a conversational service, a streaming service, an interactive service and a background service.

45. A telecommunications node comprising:
a processor for receiving router advertisement (RA) messages and for updating a Gateway GPRS Support Node (GGSN) list which is used to assign a GGSN to locally support a request for data service,
wherein said processor invokes a home GGSN IP address discovery mechanism when said request is unable to be locally supported.

46. A telecommunications method comprising the steps of:
receiving router advertisement (RA) messages;
updating a Gateway GPRS Support Node (GGSN) list using said RA messages;
assigning a GGSN to locally support a request for data service, and
invoking, if said request cannot be supported locally, a home GGSN IP address discovery mechanism.
